(19) United States
(12) Patent Application Publication
(10) Pub. No.: US 2006/0112717 A1
(43) Pub. Date: Jun. 1, 2006

(54) Bag-in-box containers and coolers

(76) Inventor: Philip Andrew Walton, Bishop Auckland (GB)

Correspondence Address: Ira S Dorman, 330 Roberts Street, Suite 200, East Hartford, CT, 06108, US

(21) Appl. No.: 10/542,615

(22) PCT Filed: Jan. 19, 2004
(86) PCT No.: PCT/GB04/00156

§ 371 Date: Jul. 15, 2005

(30) Foreign Application Priority Data
Jan. 21, 2003 (GB) 0301372.9

(51) Int. Cl. B65D 5/56; B65D 17/00; F25D 3/08; B67D 5/62; B65D 3/00

(52) U.S. Cl. 62/371; 229/117.35; 229/117.3; 229/242; 62/389

(57) ABSTRACT

A bag-in-box container 1 has a box 10 forming a relatively rigid outer casing with top, bottom and side walls, 11, 12, 13 and 14. An inner liner 15 provides a bag formed of a flexible material with a liquid outlet 16 extending through an opening in the casing. The side walls of the outer casing are formed to provide at least one further opening 18 adjacent to the bottom of the container. A cooler is also provided to cool the contents of the container 1. The cooler has a support surface 21 for supporting the container and a cooling system which includes at least one cooling probe 23 mounted to project generally parallel to the support surface for insertion through the opening or openings 18 between the bag and the box.

### TECHNICAL FIELD OF THE INVENTION

This invention relates to bag-in-box liquid containers and coolers for use with such containers.

### BACKGROUND

Many liquids are distributed in a kind of container which is generally known as a bag-in-box container. Common examples include wine, water, milk, juices, blood and other medical products. Such containers have an outer protective casing (the box) which is generally formed of cardboard or another relatively rigid material, and the liquid is held within an impermeable inner liner (the bag) which is formed of a flexible material such as plastic. The bag is often provided with a dispensing valve which projects through an opening in the box to allow the contents to be removed from the bag. Such containers have many advantages over other forms of container. They are robust, lightweight and inexpensive, and since the bag collapses as the liquid is removed, the contents are protected from contact with air until the container is almost empty. Many products deteriorate on contact with air so that the product has a longer shelf life in a bag-in-box container. Furthermore, if the liquid is sealed into the bag under sterile conditions there is minimal risk of contamination with dirt or bacteria prior to use.

Some liquid products need to be stored and/or dispensed at a temperature which is below ambient. The cooling of products in bag-in-box containers presents somewhat of a problem since the most suitable materials for the box are generally good heat insulators. Furthermore, when a proportion of the liquid is removed the increasing air space between the bag and the box also forms an additional layer of heat insulation. A common method of chilling the contents of a bag-in-box container is to place the entire container into a chilled enclosure, but this requires considerable time and heat energy to chill the liquid to the required level. A more efficient method is to remove a portion of the box to expose an area of the bag to a chilled heat exchange surface, but this entails a considerable risk of damaging the bag, and also inconveniences the user.

The present invention seeks to provide a new and inventive form of bag-in-box container and a new and inventive cooling apparatus for use with the container which entail a minimum of inconvenience for the user and provide more rapid and effective cooling of the contents.

### SUMMARY OF THE INVENTION

The present invention provides a bag-in-box container having a box forming a relatively rigid outer casing with top, bottom and side walls, and an inner liner providing a bag formed of a flexible material with a liquid outlet extending through an opening in the outer casing, in which the side walls are formed to provide at least one second opening adjacent to the bottom of the container through which a cooling probe can be inserted between the casing and the liner.

The invention also provides liquid cooling apparatus which includes a support surface for supporting a bag-in-box liquid container and a cooling system which includes at least one cooling probe which is mounted to project generally parallel to said support surface spaced a short distance there-above for insertion into said container between the bottom of the bag and the bottom of the box.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a side view of a bag-in-box container and cooler in accordance with the invention;

FIG. 2 is a similar view to FIG. 1 showing the container installed on the cooler;

FIGS. 3 to 7 are general views of five different forms of the cooler;

FIGS. 8 to 14 are general views of seven different forms of the container; and

FIG. 15 is a vertical sectional detail of the container.

### DETAILED DESCRIPTION OF THE DRAWINGS

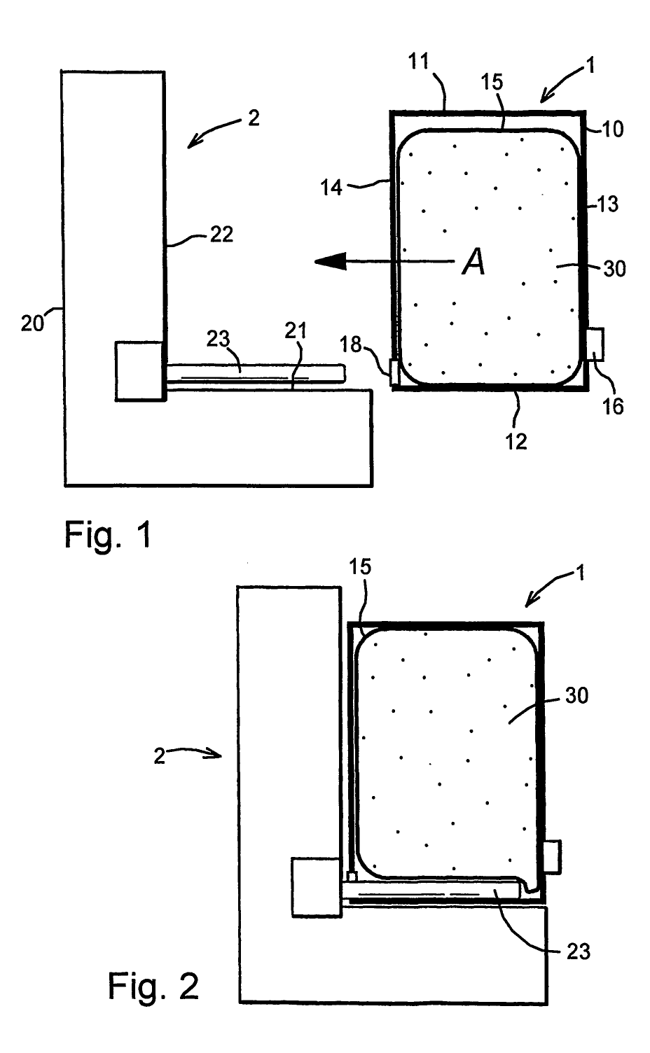

Referring firstly to FIG. 1, a bag-in-box container is indicated generally at 1 and a cooler for use with the container is indicated generally at 2.

The container 1 includes a box 10 forming a relatively rigid outer casing formed of cardboard, sheet plastic or other suitable material. The box has rectangular top and bottom walls 11 and 12, joined by four upstanding rectangular side walls, only the front and rear walls 13 and 14 being visible in the drawings. The box has an inner liner 15 of a flexible material forming a bag which is substantially filled with liquid 30 and held free within the box. The bag has a liquid outlet 16 which extends through an opening in the box 10 towards the bottom of the front wall 13. The outlet may incorporate a discharge valve, but it may also be connected by a length of tubing to a remote discharge valve. The outlet could also be located at the top of the box with a dip tube extending inside the bag to remove liquid from the bottom of the container. The box has at least one second opening 18 provided in the side walls immediately above the bottom wall 12. In this case the opening is formed in the rear wall 14. The form of the or each second opening is described in more detail below.

The cooler 2 includes a housing 20 forming a horizontal platform 21, configured to support the container 1, and an upstanding rear wall 22. A cooling probe 23 projects from the rear wall 22 generally parallel to the support platform 21 and spaced a short distance above the platform. The probe can be cooled by known means such as condenser coils included in a refrigerant cooling system of the kind including a compressor, an expansion valve and an evaporator. A thermoelectric cooling system could also be used, if desired.

The box is slid onto the platform 21 in the direction of the arrow A shown in FIG. 1, so that the cooling probe 23 enters the opening or openings 18 and passes into the container between the bag 15 and the bottom wall 12, as shown in FIG. 2, slightly displacing the bag upwardly within the box. Since the probe is disposed between the box and the liner the probe is in close heat exchange contact with the liquid 30 through the wall of the liner, ensuring that the contents are cooled very quickly and efficiently.

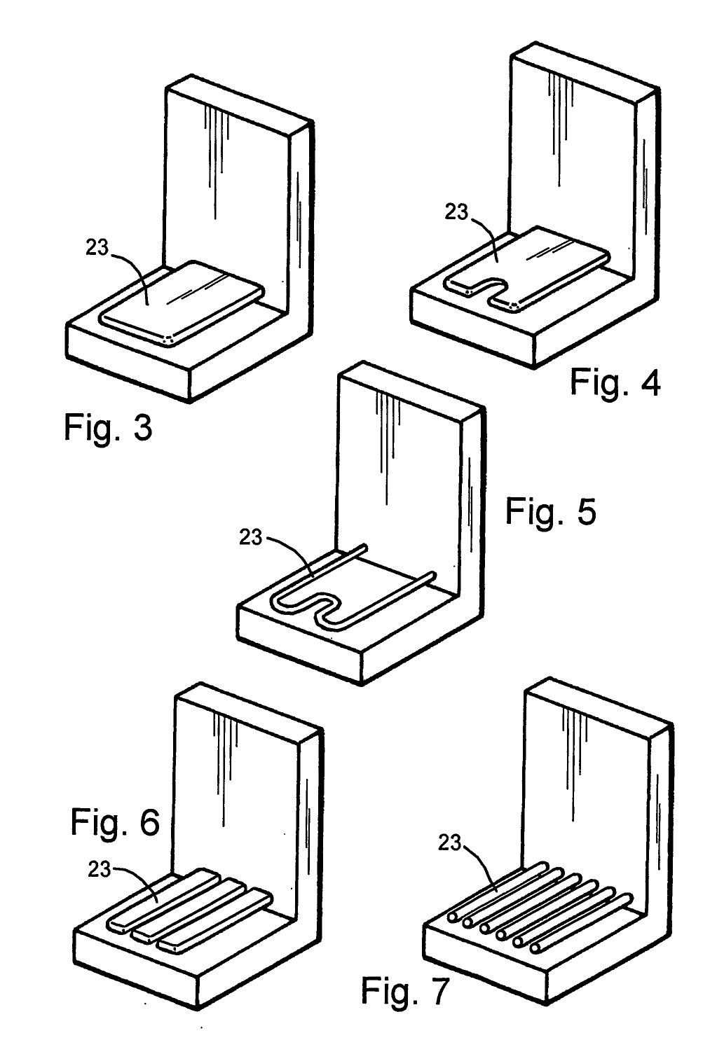

To ensure maximum efficiency the cooling probe is preferably of a generally planar configuration, but it may take various forms. For example, the probe 23 may be a flat plate as shown in FIG. 3, possibly with a bifurcated leading end as in FIG. 4. Another possibility is a single cooling element bent into a planar serpentine configuration as in the simple example shown in FIG. 5. The plate may also be divided to form a group of two or more separate probes as shown in FIGS. 6 and 7.

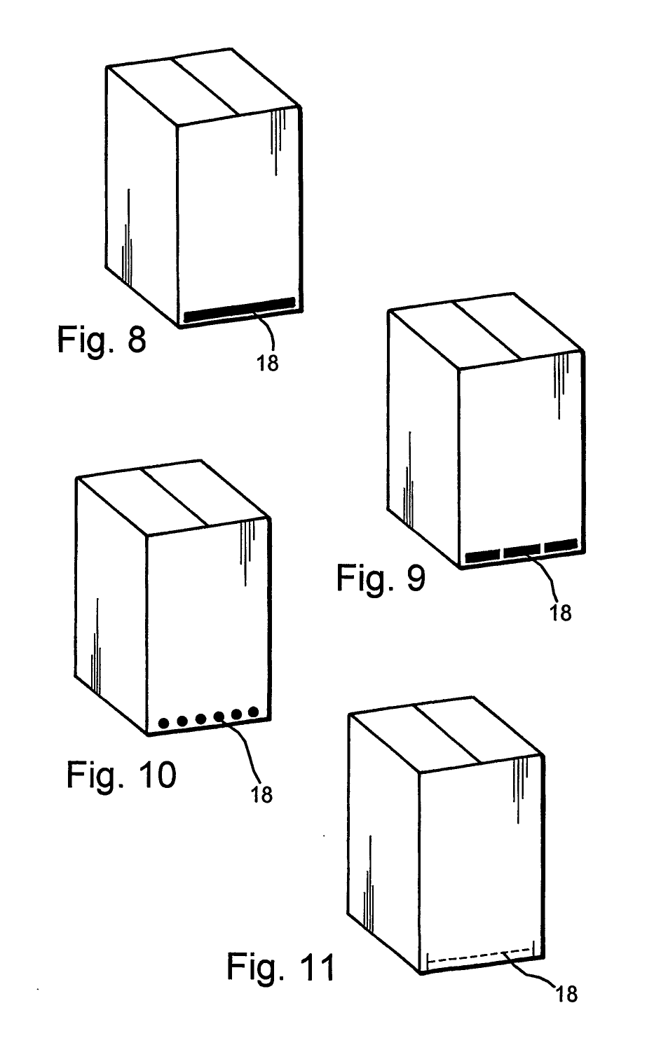

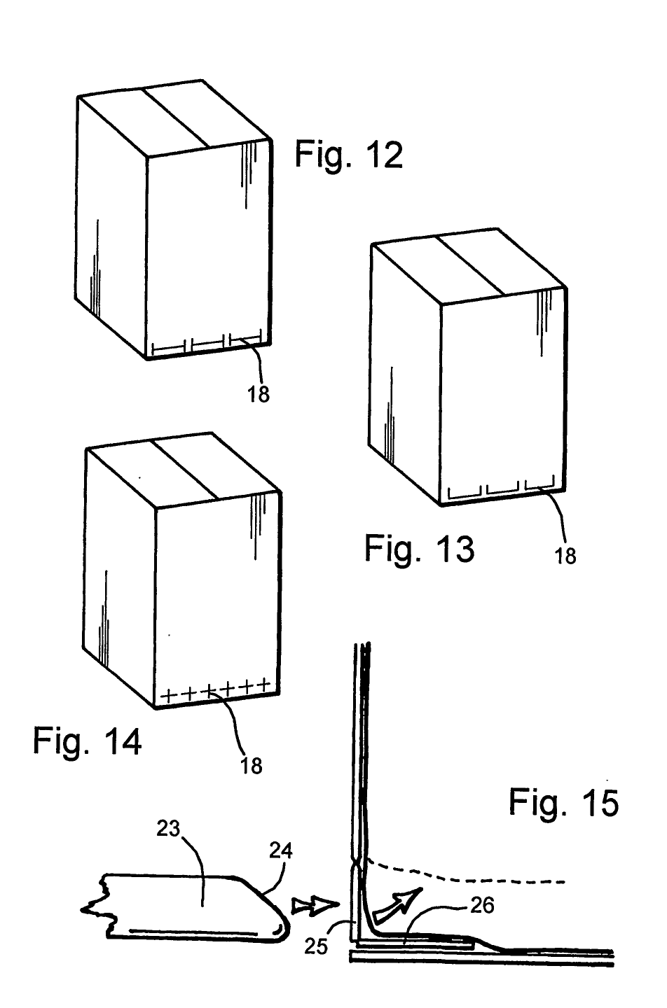

The box may have a single slot-like opening 18 to receive a single cooling probe as shown in FIG. 8, but to avoid weakening the box it is preferable to provide a row of separate openings to receive a group of separate probes as shown in FIGS. 9 and 10 which are suitable for use with the coolers of FIGS. 6 and 7 respectively. Rather than having one or more discrete openings the box may have perforations to define openings which are burst-through by the leading end of the cooling probe 23. Thus, a single row of perforations may be provided as in FIG. 11, preferably with perpendicular rows of perforations at each end to form one or more flaps which move inwards as the probe is inserted. Separate probes may have respective groups of perforations provided in an H or U configuration as in FIGS. 12 and 13, and when the cross-sectional area of the individual probes is small the perforations may be in a cruciform configuration as in FIG. 14.

In order to ensure smooth insertion of the cooling probe 23 beneath the bag 15 its leading end may be smoothly curved, preferably with a chamfered upper edge 24 as shown in FIG. 15. The risk of damaging the bag may be further reduced by providing an internal hinged flap 25 which is moved upwardly by the probe to push the bag out of the way, as indicated by dashed lines. The flap may have two or more additional hinged sections 26, and it may be formed by the wall of the box 10 as shown or provided as a separate element fixed within the box.

As the container is emptied the bag 15 slowly collapses in known manner, but the weight of the liquid maintains effective cooling contact with the probe 23.

Although it is preferred to insert the cooling probe beneath the bag for most efficient cooling it would also be possible to insert a probe alongside the bag towards the bottom of the container.

It will be appreciated that the features disclosed herein may be present in any feasible combination. Whilst the above description lays emphasis on those areas which, in combination, are believed to be new, protection is claimed for any inventive combination of the features disclosed herein.

1. A bag-in-box container (1) having a box (10) forming a relatively rigid outer casing with top, bottom and side walls (11, 12, 13 and 14), and an inner liner (15) providing a bag formed of a flexible material with a liquid outlet (16) extending through an opening in the outer casing,
characterised in that
the side walls are formed to provide at least one further opening (18) adjacent to the bottom of the container through which a cooling probe (23) can be inserted between the casing and the liner.

2. A bag-in-box container according to claim 1, in which the or each further opening is formed by a discrete aperture in the container.

3. A bag-in-box container according to claim 1, in which the or each further opening is formed by a line of perforations defining a portion of the casing which can be burst through by a cooling probe.

4. A bag-in-box container according to claim 1, in which the or each further opening is provided with a flap (25) which is hinged to move against the bag when the probe is inserted.

5. Liquid cooling apparatus
characterised by
a support surface (21) for supporting a bag-in-box liquid container and a cooling system which includes at least one cooling probe (23) which is mounted to project generally parallel to the support surface and spaced a short distance above the support surface for insertion into the container between the bag (15) and the box (10).

6. Liquid cooling apparatus according to claim 5, in which the cooling probe or probes is/are arranged in generally planar configuration.
